(19) United States
(12) Patent Application Publication
(10) Pub. No.: US 2026/0032658 A1
(43) Pub. Date: Jan. 29, 2026

(54) RADIO ACCESS TECHNOLOGY (RAT) OPERATION MANAGEMENT

(71) Applicant: QUALCOMM Incorporated, San Diego, CA (US)

(72) Inventors: Kamalakar GANTI, San Marcos, CA (US); Thawatt GOPAL, San Diego, CA (US); Shriram GURUMOORTHY, Denver, CO (US)

(21) Appl. No.: 19/277,102

(22) Filed: Jul. 22, 2025

Related U.S. Application Data
(60) Provisional application No. 63/676,822, filed on Jul. 29, 2024.

(51) Int. Cl. H04W 72/0453; H04W 4/80; H04W 84/12

(52) U.S. Cl. CPC H04W 72/0453; H04W 4/80; H04W 84/12

(57) ABSTRACT

Techniques and apparatus for radio access technology (RAT) operation management are provided. One example technique generally includes (i) detecting a condition involving concurrent operation of two or more RATs in a first radio frequency (RF) band and a second RF band, where the first and second RF bands comprise at least one of adjacent or overlapping RF bands, (ii) disabling operation of at least a first RAT of the two or more RATs on at least a portion of the first RF band based on the detecting of the condition, (iii) performing one or more actions to adjust one or more RF operation parameters while operation of the first RAT is disabled, and (iv) enabling operation of the first RAT on at least the portion of the first RF band concurrent with operating on the second RF band using a second RAT after performing the one or more actions.

### CROSS-REFERENCE TO RELATED APPLICATION(S)

The present application claims the benefit of and priority to U.S. Provisional Application No. 63/676,822, filed Jul. 29, 2024, which is expressly incorporated by reference herein in its entirety as if fully set forth below and for all applicable purposes.

### TECHNICAL FIELD

Certain aspects of the present disclosure generally relate to electronic circuits and, more particularly, to techniques and apparatus for radio access technology (RAT) operation management.

### BACKGROUND

Wireless communication devices are widely deployed to provide various communication services such as telephony, video, data, messaging, broadcasts, and so on. Such wireless communication devices may transmit and/or receive radio frequency (RF) signals via any of various suitable radio access technologies (RATs) including, but not limited to, 5G New Radio (NR), Long Term Evolution (LTE), Code Division Multiple Access (CDMA), Time Division Multiple Access (TDMA), Wideband CDMA (WCDMA), Global System for Mobility (GSM), Bluetooth, Bluetooth Low Energy (BLE), ZigBee, wireless local area network (WLAN) RATs (e.g., WiFi), and the like.

A wireless communication network may include a number of base stations that can support communication for a number of mobile stations. A mobile station (MS) may communicate with a base station (BS) via a downlink and an uplink. The downlink (or forward link) refers to the communication link from the base station to the mobile station, and the uplink (or reverse link) refers to the communication link from the mobile station to the base station. A base station may transmit data and control information on the downlink to a mobile station and/or may receive data and control information on the uplink from the mobile station. The mobile station may include RF front-end circuitry which may be used, for example, for signal processing (e.g., filtering).

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide the advantages described herein.

Certain aspects of the present disclosure are directed to a method. The method generally includes detecting a condition involving concurrent operation of one or more radio access technologies (RATs) in a first radio frequency (RF) band and a second RF band, where the first and second RF bands comprise at least one of adjacent or overlapping RF bands and performing one or more actions to adjust one or more RF operation parameters based on the detecting of the condition.

Certain aspects of the present disclosure are directed to a method. The method generally includes detecting a condition involving concurrent operation of two or more RATs in a first RF band and a second RF band, where the first and second RF bands comprise at least one of adjacent or overlapping RF bands, disabling operation of at least a first RAT of the two or more RATs on at least a portion of the first RF band based on the detecting of the condition, performing one or more actions to adjust one or more RF operation parameters while operation of the first RAT is disabled, and enabling operation of the first RAT on at least the portion of the first RF band concurrent with operating on the second RF band using a second RAT after performing the one or more actions.

Certain aspects of the present disclosure provide an RF front-end circuit. The RF front end circuit generally includes a first filter, a second filter, an RF module, and one or more switches configured to selectively establish: a first path from an antenna and through the first filter to the RF module; and a second path from the antenna and through the second filter to the RF module, where a bandwidth of the first filter overlaps with a bandwidth of the second filter and where the bandwidth of the first filter is narrower than the bandwidth of the second filter.

Certain aspects of the present disclosure provide an apparatus for wireless communications. The apparatus for wireless communications generally includes memory comprising computer-executable instructions and one or more processors, individually or collectively, configured to execute the computer-executable instructions and cause the apparatus, to: (i) detect a condition involving concurrent operation of two or more RATs in a first RF band and a second RF band, where the first and second RF bands comprise at least one of adjacent or overlapping RF bands, (ii) disable operation of at least a first RAT of the two or more RATs on at least a portion of the first RF band based on the detection of the condition, (iii) perform one or more actions to adjust one or more RF operation parameters while operation of the first RAT is disabled, and (iv) enable operation of the first RAT on at least the portion of the first RF band concurrent with operating on the second RF band using a second RAT after the one or more actions are performed.

Certain aspects of the present disclosure provide an apparatus for wireless communications. The apparatus generally includes means for detecting a condition involving concurrent operation of two or more RATs in a first RF band and a second RF band, where the first and second RF bands comprise at least one of adjacent or overlapping RF bands, means for disabling operation of at least a first RAT of the two or more RATs on at least a portion of the first RF band based on the detection of the condition, means for performing one or more actions to adjust one or more RF operation parameters while operation of the first RAT is disabled, and means for enabling operation of the first RAT on at least the portion of the first RF band concurrent with operating on the second RF band using a second RAT after the one or more actions are performed.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in which aspects of the present disclosure may be practiced.

FIG. 2 is a block diagram conceptually illustrating a design of an example a base station (BS) and user equipment (UE), in which aspects of the present disclosure may be practiced.

FIG. 3 illustrates example adjacent frequency bands without a guard band for an example use case scenario, in accordance with certain aspects of the present disclosure.

FIG. 4 is a flow diagram of example operations for radio access technology (RAT) operation management, in accordance with certain aspects of the present disclosure.

FIGS. 5A and 5B illustrate example radio frequency (RF) front-end circuits during the operations 400 of FIG. 4, in accordance with certain aspects of the present disclosure.

FIGS. 6A and 6B illustrate example frequency spectrums associated with the RF front-end circuits of FIGS. 5A and 5B, in accordance with certain aspects of the present disclosure.

FIG. 7 is a flow diagram of example operations when the N53 band is enabled, in accordance with certain aspects of the present disclosure.

FIG. 8 is a flow diagram of example operations when the N53 band is disabled, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

The 2.4 GHz industrial, scientific, and medical (ISM) band (which ranges from 2400 to 2483 MHz) is currently shared by different radio access technologies (RATs), such as Bluetooth (BT), BT Low Energy (BLE), and wireless local area network (WLAN) RATs. Currently, most BT and BLE operations are limited to the 2.4 GHz ISM band (however, BT/BLE 5/6 GHz operations are possible), while WLAN may use other bands (e.g., the 5 GHz band and/or the 6 GHz band) in addition to the 2.4 GHz ISM band. Managing the use of the 2.4 GHz ISM band by the different RATs may be crucial, especially given the relatively narrow bandwidth of the 2.4 GHz ISM band (when compared to the use 5 GHz and/or 6 GHz bands).

N53 refers to a terrestrial band with an 11.5 MHz spectrum (from 2483.5 to 2495 MHz) adjacent to the 2.4 GHz ISM band. The N53 band is intended for use by private networks. Unfortunately, because the N53 band is adjacent to the 2.4 GHz ISM band, activity on either band may result in significant radio frequency (RF) desense for devices operating on the N53 band and the 2.4 GHz ISM band. RF desense generally refers to a situation where the sensitivity of a wireless receiver to incoming signals is reduced due to electromagnetic interference. Further, in-device coexistence may present a challenge, due to the lack of a guard band between the N53 band and the 2.4 GHz ISM band. Many desense mitigation techniques commonly used for other problematic band combinations may be insufficient to address these issues.

Certain aspects of the present disclosure provide techniques and apparatus for an RF front-end circuit with RAT operation management. The RAT operation management described herein may involve mitigating RF desense between the N53 band and the 2.4 GHz ISM band by using one or more switches to select between a signal path with a narrow N53-specific filter (when operation on the N53 band is desired) and a signal path with a wideband 2.4 GHz ISM band (when operation on the N53 band is not desired). Switching to the narrow N53-specific filter may enable the formation of a guard band (e.g., a 20 MHz guard band) in the 2.4 GHz ISM band, resulting in a narrower 2.4 GHz band (referred to as a “restricted spectrum”).

As a result of the introduction of the guard band, WLAN/BT/BLE RAT concurrency in the restricted spectrum and the N53 band may be enabled. During switching between the narrow N53-specific filter and the wideband 2.4 GHz ISM band, operation on the 2.4 GHz ISM band may be temporarily halted to avoid damaging circuitry (e.g., a power amplifier (PA)) in the RF front-end circuit. The RAT operation management described herein may also facilitate prioritization between BT/BLE and WLAN 2.4 GHz RATs in the restricted spectrum in accordance with current operating conditions to maximize performance (e.g., by limiting BT/BLE to white-listed channels in the 2.4 GHz ISM band and/or disabling WLAN in the 2.4 GHz ISM band).

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Wireless System

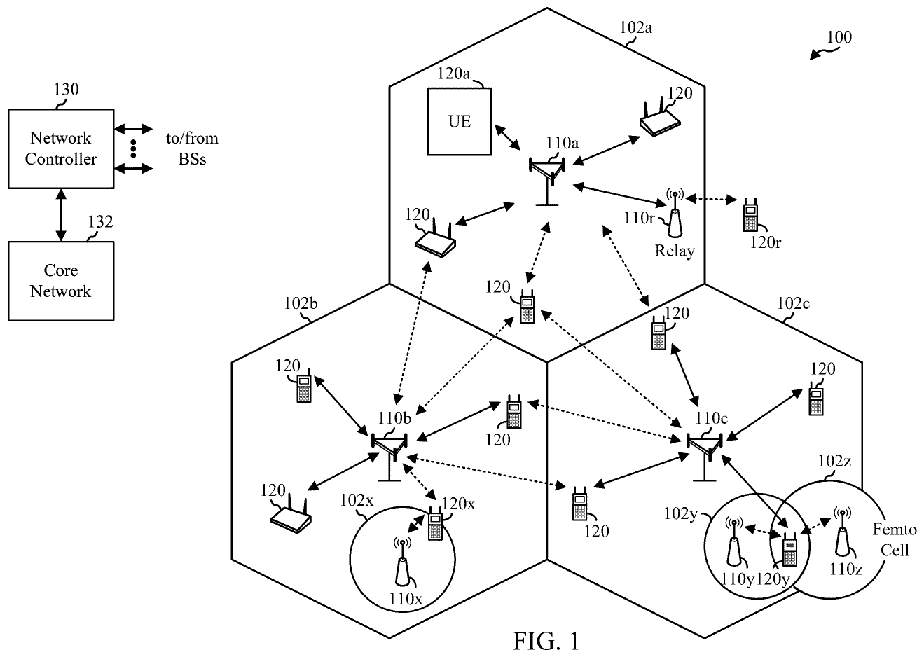

FIG. 1 illustrates an example wireless communications network 100, in which aspects of the present disclosure may be practiced. For example, the wireless communications network 100 may be a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation/Third Generation (2G/3G) network), or a code division multiple access (CDMA) system (e.g., a 2G/3G network), or may be configured for communications according to an IEEE standard such as one or more of the 802.11 standards, etc.

As illustrated in FIG. 1, the wireless communications network 100 may include a number of base stations (BSs) 110a-z (each also individually referred to herein as “BS 110” or collectively as “BSs 110”) and other network entities. A BS may also be referred to as an access point (AP), an evolved Node B (eNodeB or eNB), a next generation Node B (gNodeB or gNB), or some other terminology.

A BS 110 may provide communication coverage for a particular geographic area, sometimes referred to as a “cell,” which may be stationary or may move according to the location of a mobile BS 110. In some examples, the BSs 110 may be interconnected to one another and/or to one or more other BSs or network nodes (not shown) in wireless communications network 100 through various types of backhaul interfaces (e.g., a direct physical connection, a wireless connection, a virtual network, or the like) using any suitable transport network. In the example shown in FIG. 1, the BSs 110a, 110b, and 110c may be macro BSs for the macro cells 102a, 102b, and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with one or more user equipments (UEs) 120a-y (each also individually referred to herein as “UE 120” or collectively as “UEs 120”) in the wireless communications network 100. A UE may be fixed or mobile and may also be referred to as a user terminal (UT), a mobile station (MS), an access terminal, a station (STA), a client, a wireless device, a mobile device, or some other terminology. A user terminal may be a wireless device, such as a cellular phone, a smartphone, a personal digital assistant (PDA), a handheld device, a wearable device, a wireless modem, a laptop computer, a tablet, a personal computer, etc.

The BSs 110 are considered transmitting entities for the downlink and receiving entities for the uplink. The UEs 120 are considered transmitting entities for the uplink and receiving entities for the downlink. As used herein, a “transmitting entity” is an independently operated apparatus or device capable of transmitting data via a frequency channel, and a “receiving entity” is an independently operated apparatus or device capable of receiving data via a frequency channel. In the following description, the subscript “dn” denotes the downlink, the subscript “up” denotes the uplink. Nᵤₚ UEs may be selected for simultaneous transmission on the uplink, N_{dn} UEs may be selected for simultaneous transmission on the downlink. Nᵤₚ may or may not be equal to N_{dn}, and Nᵤₚ and N_{dn} may be static values or can change for each scheduling interval. Beam-steering or some other spatial processing technique may be used at the BSs 110 and/or UEs 120.

The UEs 120 (e.g., 120x, 120y, etc.) may be dispersed throughout the wireless communications network 100, and each UE 120 may be stationary or mobile. The wireless communications network 100 may also include relay stations (e.g., relay station 110r), also referred to as relays or the like, that receive a transmission of data and/or other information from an upstream station (e.g., a BS 110a or a UE 120r) and send a transmission of the data and/or other information to a downstream station (e.g., a UE 120 or a BS 110), or that relays transmissions between UEs 120, to facilitate communication between devices.

The BSs 110 may communicate with one or more UEs 120 at any given moment on the downlink and uplink. The downlink (i.e., forward link) is the communication link from the BSs 110 to the UEs 120, and the uplink (i.e., reverse link) is the communication link from the UEs 120 to the BSs 110. A UE 120 may also communicate peer-to-peer with another UE 120.

The wireless communications network 100 may use multiple transmit and multiple receive antennas for data transmission on the downlink and uplink. BSs 110 may be equipped with a number Nap of antennas to achieve transmit diversity for downlink transmissions and/or receive diversity for uplink transmissions. A set Nu of UEs 120 may receive downlink transmissions and transmit uplink transmissions. Each UE 120 may transmit user-specific data to and/or receive user-specific data from the BSs 110. In general, each UE 120 may be equipped with one or multiple antennas. The Nu UEs 120 can have the same or different numbers of antennas.

The wireless communications network 100 may be a time division duplex (TDD) system or a frequency division duplex (FDD) system. For a TDD system, the downlink and uplink share the same frequency band. For an FDD system, the downlink and uplink use different frequency bands. The wireless communications network 100 may also utilize a single carrier or multiple carriers for transmission. Each UE 120 may be equipped with a single antenna (e.g., to keep costs down) or multiple antennas (e.g., where the additional cost can be supported).

A network controller 130 (also sometimes referred to as a “system controller”) may be in communication with a set of BSs 110 and provide coordination and control for these BSs 110 (e.g., via a backhaul). In certain cases (e.g., in a 5G NR system), the network controller 130 may include a centralized unit (CU) and/or a distributed unit (DU). In certain aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

In certain aspects of the present disclosure, the BSs 110 and/or the UEs 120 may include a digital-to-analog converter (DAC) with an adaptive calibration scheme, as described in more detail herein.

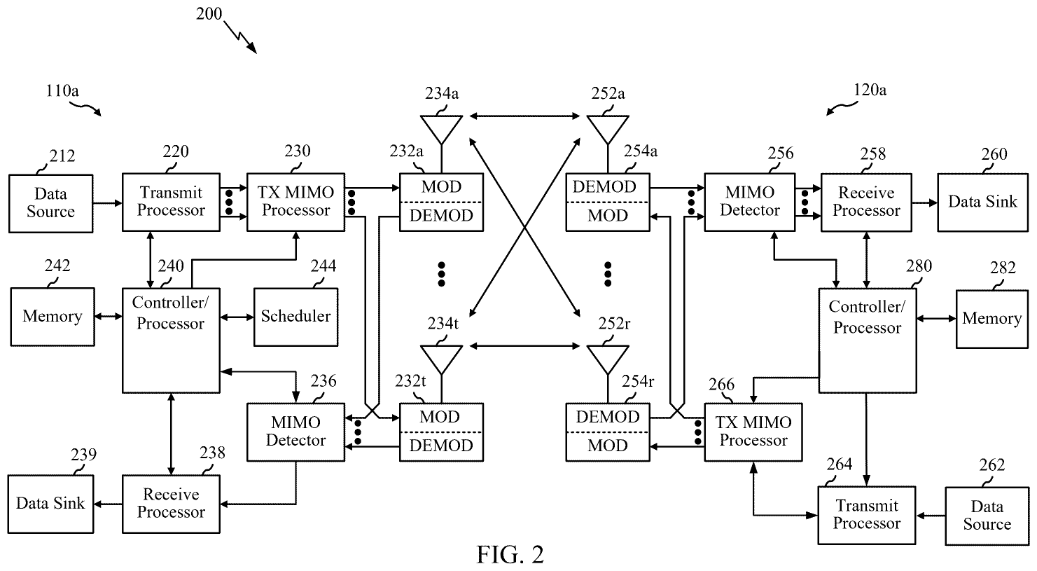

FIG. 2 illustrates example components of BS 110a and UE 120a (e.g., from the wireless communications network 100 of FIG. 1), in which aspects of the present disclosure may be implemented.

On the downlink, at the BS 110a, a transmit processor 220 may receive data from a data source 212, control information from a controller/processor 240, and/or possibly other data (e.g., from a scheduler 244). The various types of data may be sent on different transport channels. For example, the control information may be designated for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), etc. The data may be designated for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS).

A transmit (TX) multiple-input, multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for orthogonal frequency division multiplexing (OFDM), etc.) to obtain an output sample stream. Each of the transceivers 232a-232t may further process (e.g., convert to analog, amplify, filter, and upconvert) the output sample stream to obtain a downlink signal. Downlink signals from the transceivers 232a-232t may be transmitted via the antennas 234a-234t, respectively.

At the UE 120a, the antennas 252a-252r may receive the downlink signals from the BS 110a and may provide received signals to the transceivers 254a-254r, respectively. The transceivers 254a-254r may condition (e.g., filter, amplify, downconvert, and digitize) a respective received signal to obtain input samples. Each demodulator (DEMOD) in the transceivers 232a-232t may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH)) from the controller/processor 280. The transmit processor 264 may also generate reference symbols for a reference signal (e.g., the sounding reference signal (SRS)). The symbols from the transmit processor 264 may be precoded by a TX MIMO processor 266 if applicable, further processed by the modulators (MODs) in transceivers 254a-254r (e.g., for single-carrier frequency division multiplexing (SC-FDM), etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. The memories 242 and 282 may also interface with the controllers/processors 240 and 280, respectively. A scheduler 244 may schedule UEs for data transmission on the downlink and/or uplink.

Antennas 252, processors 258, 264, 266, and/or controller/processor 280 of the UE 120a and/or antennas 234, processors 220, 230, 238, and/or controller/processor 240 of the BS 110a may be used to perform the various techniques and methods described herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The system bandwidth may also be partitioned into subbands. For example, a subband may cover multiple resource blocks (RBs).

### Example Radio Access Technology (RAT) Operation Management

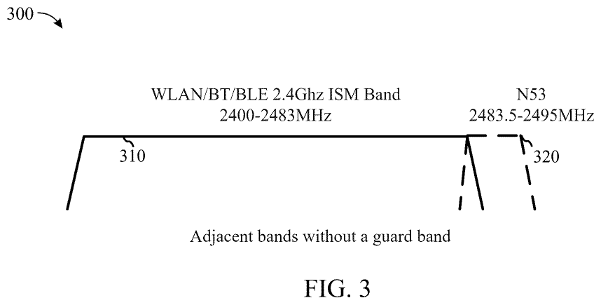

FIG. 3 illustrates a diagram 300 of example adjacent frequency bands without a guard band for an example use case scenario. As described above, the 2.4 GHz ISM band 310 may range from 2400 to 2483 MHz and the adjacent N53 band 320 may range from 2483.5 to 2495 MHz, as shown. The lack of a guard band between the 2.4 GHz ISM band 310 and the adjacent N53 band 320 may result in significant RF desense for devices operating on the 2.4 GHz ISM band and the N53 band that may not be adequately addressed to allow for desired concurrent radio access technology (RAT) operation with desense mitigation techniques used for other problematic band combinations.

Certain aspects of the present disclosure provide techniques and apparatus for managing concurrent operation for WLAN/BT/BLE RATs across the 2.4 GHz ISM band and the N53 band. It should be noted that BT, BLE, and WLAN are just example RATs and that the techniques proposed herein may be used with various other types of RATs in different implementations. It should also be noted that the 2.4 GHz ISM band and the N53 band are just example bands and that the techniques proposed herein may be used with various other bands in different implementations.

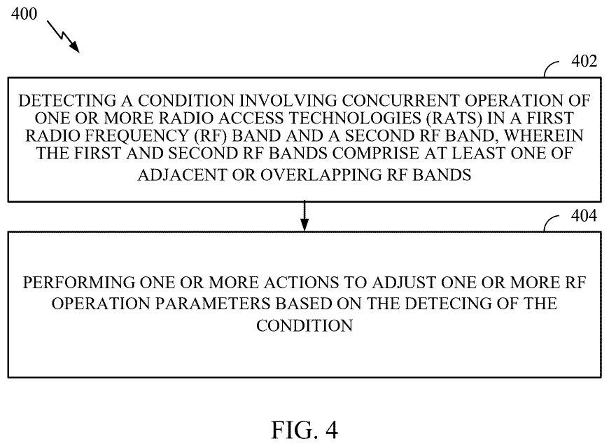

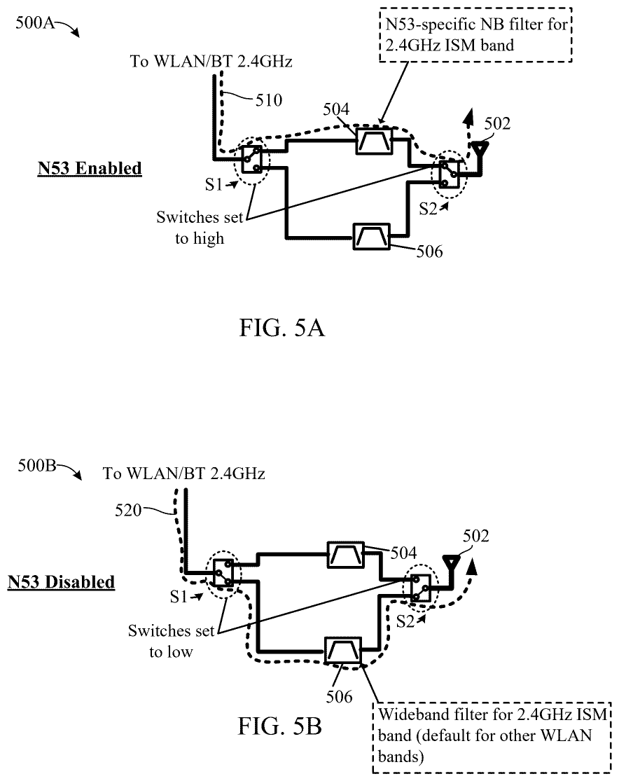

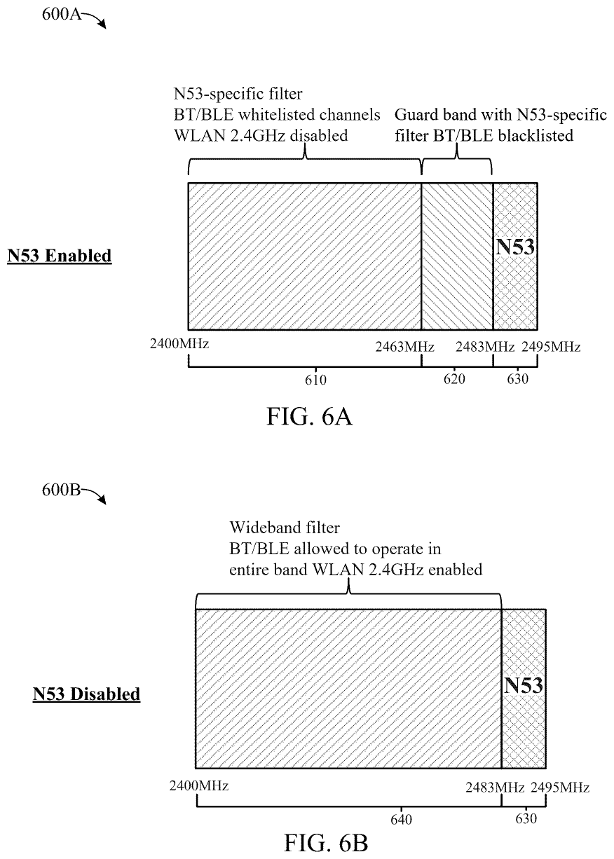

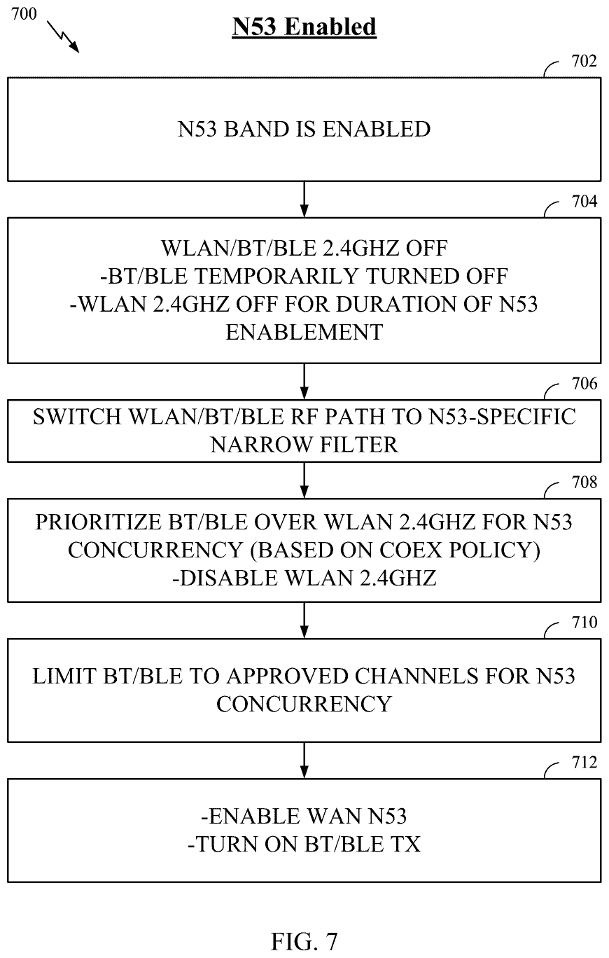

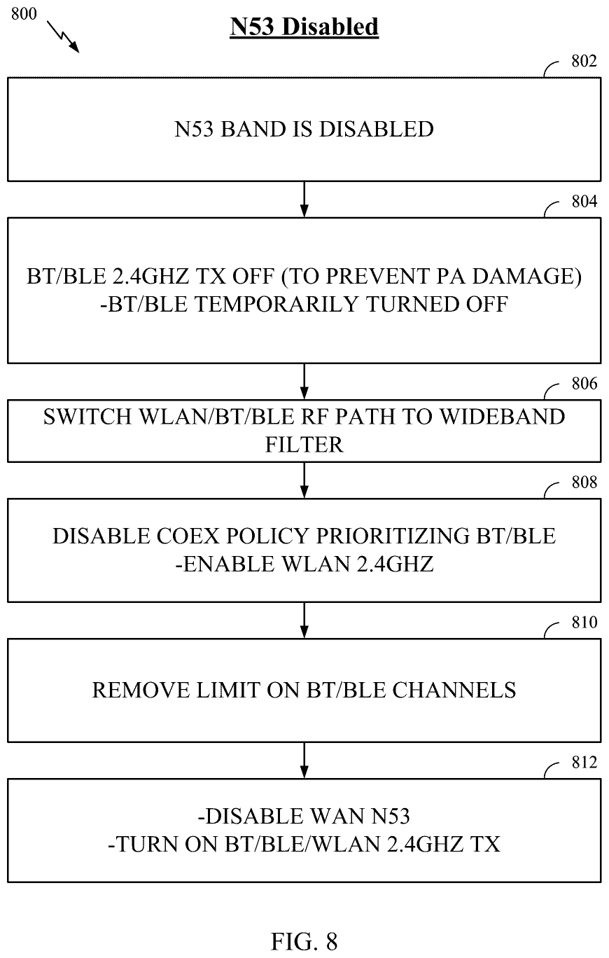

FIG. 4 is a flow diagram of example operations 400 for RAT operation management, in accordance with certain aspects of the present disclosure. FIGS. 5A and 5B illustrate example RF front-end circuits 500A, 500B during the operations 400 of FIG. 4, in accordance with certain aspects of the present disclosure. FIGS. 6A and 6B illustrate example frequency spectrums 600A, 600B associated with the RF front-end circuits 500A, 500B of FIGS. 5A and 5B, in accordance with certain aspects of the present disclosure. FIG. 7 is a flow diagram of example operations 700 when the N53 band is enabled, in accordance with certain aspects of the present disclosure. FIG. 8 is a flow diagram of example operations 800 when the N53 band is disabled, in accordance with certain aspects of the present disclosure. Therefore, FIGS. 4, 5A, 5B, 6A, 6B, 7A, and 7B are herein described together for clarity.

The operations 400 include, at block 402, detecting a condition involving concurrent operation of one or more RATs in a first RF band (e.g., the 2.4 GHz ISM band) and a second RF band (e.g., the N53 band). The one or more RATs may include at least one of BT, BLE, or WLAN RATs. The first and second RF bands may be adjacent or overlapping RF bands, as illustrated and described in FIG. 3 above.

The condition at block 402 may involve detecting (activity on) an N53 band 630 (private network N53 band which ranges from 2483 to 2495 MHz) illustrated in FIGS. 6A and 6B is enabled (e.g., block 702 of operations 700) or detecting that the N53 band 630 is disabled (e.g., block 802 of operations 800). In some cases, the condition at block 402 may involve detecting the N53 band is disabled a period of time after detecting the N53 band is enabled.

Detecting that the N53 band 630 is enabled or disabled may involve using one or more of a unique public land mobile network (PLMN) identification, a dedicated subscriber identity module (SIM) card, a channel acquisition procedure, an idle mobility procedure, or a connected mobility procedure to detect the whether the N53 band 630 is enabled or disabled. In certain aspects, a user equipment (UE) may determine that its location is in a geographical region where the N53 band is the dominant coverage, for example, during operation or when powering up. In these aspects, the UE may assume that the N53 band 630 is enabled and proceed to perform the operations 700.

In certain aspects, operation of at least one first RAT (e.g., BT, BLE, WLAN, and/or wide area network (WAN)) on at least a portion of the first RF band may be temporarily disabling while performing the one or more actions at block 404. In these aspects, operation of the at least one first RAT on at least a portion of the first RF band may be enabled concurrent with operating on the second RF band using a second RAT (e.g., BT, BLE, WLAN, or WAN) after performing the one or more actions at block 404. For example, one or more of BT and BLE operation (e.g., transmission) on the 2.4 GHz ISM band 640 may be temporarily disabled (e.g., turned off) after the condition at block 402 (e.g., N53 enabled) is detected and while the one or more actions at block 404 are performed (e.g., block 704 of operations 700). In this manner, circuitry (e.g., a PA) in the RF front-end circuit(s) associated with the one or more RATs may be protected from damage. In some cases, the at least one RAT may include at least one of BT or BLE, and the second RAT may include WAN. In certain aspects, BT, BLE, and/or WLAN operation may be disabled on at least a portion of the 2.4 GHz ISM band 640 based on the detecting of the condition at block 402. In these aspects, BT and/or BLE operation on at least the portion of the 2.4 GHz ISM band 640 may be enabled concurrent with operating on the second RF band using the second RAT after performing the one or more actions at block 404.

In certain aspects, operation of at least one RAT (e.g., WLAN 2.4 GHz) of the one or more RATs may be disabled based on the detecting of the condition at block 402 and may remain disabled after performing the one or more actions at block 404 for at least a duration of the detecting of the condition (e.g., a duration of the enablement of the N53 band, for example, until block 808 during operations 800). For example, WLAN 2.4 GHz transmission may be disabled (e.g., turned off) after the condition at block 402 is detected while the one or more actions at block 404 are performed (e.g., block 704 of operations 700) and for at least the duration of the enablement of the N53 band.

In certain aspects, WLAN 5 GHz and/or WLAN 6 GHz may continue to be enabled after the condition at block 402 is detected, even as WLAN 2.4 GHz is disabled. For example, WLAN 5 GHz and/or WLAN 6 GHz may be on a different antenna path than the first path 510 and the second path 520 to allow for the operation of WLAN 5 GHz and/or WLAN 6 GHz while the N53 band is enabled.

At block 404, the operations 400 include performing one or more actions to adjust one or more RF operation parameters based on the detecting of the condition at block 402.

In certain aspects, the one or more actions at block 404 may include creating a restricted spectrum 610 (from 2400 to 2463 MHz) by forming a guard band 620 (e.g., a 20 MHz guard band, such as a 20 MHz guard band from 2463 to 2483 MHz) using a portion of the first RF band that is at least one of adjacent to or overlapping the second RF band, as illustrated in FIG. 6A. Although the guard band 620 illustrated in FIG. 6A is a 20 MHz guard band, it is to be understood that the guard band may have any frequency width.

In certain aspects, the guard band 620 may be created by switching an RF path to a first path 510 that includes a narrow band filter 504 associated with the N53 band 630 (e.g., block 706 of operations 700) using switches S1 and S2 (switched to the high side), as illustrated in FIG. 5A.

The narrow band filter 504 may be an N53-specific narrow band filter, and may be configured to accommodate one or more BLE advertising channels. For example, the narrow band filter 504 may preserve two BLE advertising channels (e.g., in the restricted spectrum 610) that may be used during BLE operation. Switches S1 and S2 may both be included in the RF front-end circuits 500A, 500B between an antenna 502 and an output to one or more RF modules associated with one or more of BT, BLE, WLAN, or other RATs. In some cases, the bandwidth of the narrow band filter 504 may be associated with the N53 band and/or may include a range of frequencies from 2400 MHz to 2463 MHz.

In certain aspects, operation of the first RAT (e.g., BT and/or BLE) of the one or more RATs may be prioritized over the second RAT (e.g., WLAN) of the one or more RATs in the restricted spectrum 610 (e.g., block 708 of operations 700).

The prioritization of the RATs may be implemented and/or referred to as a coexistence policy. In certain aspects, the coexistence policy may include or be accomplished by disabling operation of the second RAT in the restricted spectrum 610 to avoid BT and/or BLE performance degradation. In this manner, BT/BLE may have a higher priority during RAT operation management than WLAN in the restricted spectrum 610.

In some cases, the coexistence policy may include or be accomplished by enabling BT and/or BLE operation in the restricted spectrum 610 and prioritizing WLAN 5 GHz over WLAN 2.4 GHz (e.g., by disabling WLAN 2.4 GHz). In these cases, when WLAN 5 GHz operation is not occurring, WLAN 2.4 GHz operation may be enabled and share the restricted spectrum 610 with BT and/or BLE.

In some cases, the coexistence policy may include or be accomplished by enabling both BT and/BLE as well as WLAN 2.4 GHz in the restricted spectrum 610 (e.g., allowing concurrent operation of both BT/BLE and WLAN 2.4 GHz in the N53 band).

In some cases, the coexistence policy may include or be accomplished by enabling WLAN 2.4 GHz and disabling BT and/or BLE 2.4 GHz in the restricted spectrum 610, while allowing BT and/or BLE 5 GHz in the 5 GHz band and/or the 6 GHz band.

In some cases, the coexistence policy may include or be accomplished by enabling BT and/or BLE operation in the 5 GHz band and/or the 6 GHz band and prioritizing WLAN 2.4 GHz in the restricted spectrum 610 (e.g., by disabling BT and/or BLE in the restricted spectrum 610) over WLAN 5 GHz when WLAN 5 GHz operation is not occurring.

In certain aspects, a UE may communicate with another peripheral device that only supports the 2.4 GHz ISM band (and not the 5 GHz and 6 GHz bands). As such, the RAT operation management described herein may prioritize WLAN operation in the 2.4 GHz ISM band (at the expense of BT/BLE operation). After the UE completes communication with the peripheral device, WLAN operation may move to the 5 GHz band and 6 GHz band, and BT/BLE operation may be prioritized in the 2.4 GHz ISM band.

In certain aspects, operation of at least a first RAT (e.g., BT and/or BLE) of the one or more RATs may be limited to approved channels (e.g., whitelisted channels) in the restricted spectrum 610 and not allowing operation of the one or more RATs on unapproved channel (e.g., blacklisted channels) located in the guard band 620 (e.g., block 710 of operations 700). In this manner, performance degradation while using BT and/or BLE may be avoided.

After the first path 510 has been selected using switches S1 and S2 and the prioritizing has been applied, WAN in the N53 band 630 may be enabled and BT and/or BLE transmission may be turned on (e.g., block 712 of operations 700). In certain aspects, WLAN 2.4 GHz operation may remain disabled while the N53 band is enabled.

In certain aspects, the N53 band 630 may be disabled and the guard band 620 may be removed in response to detecting that the N53 band 630 is disabled (forming an unrestricted spectrum (e.g., 2.4 GHz ISM band 640)). It is to be understood that the condition at block 402 may involve detecting that the N53 band 630 is disabled without the N53 band 630 having been previously enabled.

In certain aspects, when the N53 band 630 is disabled, the guard band 620 may be removed by switching an RF path to a second path 520 that includes a wideband filter 506 (e.g., block 806 of operations 800) using switches S1 and S2 (switched to the low side), as illustrated in FIG. 5B. Switches S1 and S2 may be controlled by a switch controller (not illustrated). The switch controller may be configured to operate switches S1 and S2 when switching between the first path 510 and the second path 520 such that circuitry (e.g., a PA) in the RF front-end circuit is protected from damage (e.g., by switching after block 704 or block 804). In some cases, the bandwidth of the wideband filter 506 may be associated with a 2.4 GHz band and/or may include a range of frequencies from 2400 MHz to 2483 MHz.

In certain aspects, operation on at least a portion of the first RF band may be temporarily disabled while removing the guard band 620. For example, one or more of BT and BLE transmission on the 2.4 GHz ISM band 640 may be temporarily disabled (e.g., turned off) after the condition at block 402 (e.g., N53 disabled) is detected while removing the guard band 620 (e.g., block 806 of operations 800). In this manner, circuitry (e.g., a PA) in the RF front-end circuit(s) associated with the one or more RATs may be protected from damage.

In certain aspects, prioritizing operation of a first RAT (e.g., BT and/or BLE) of the one or more RATs over a second RAT (e.g., WLAN) of the one or more RATs in the restricted spectrum 610 may be disabled by enabling operation of the second RAT in the first RF band (e.g., block 808 of operations 800). The disabling of prioritizing may be accomplished by enabling operation of the second RAT in the 2.4 GHz ISM band 640.

In certain aspects, the limitation of operation of at least a first RAT (e.g., BT and/or BLE) of the one or more RATs to approved channels (e.g., whitelisted channels) in the restricted spectrum 610 (e.g., block 810 of operations 800) may be removed. In this manner, the entire 2.4 GHz ISM band 640 is operational (e.g., whitelisted) and BT and/or BLE may operate in the entirety of the 2.4 GHz ISM band 640, as illustrated in FIG. 6B.

After the second path 520 has been selected using switches S1 and S2 and the prioritizing has been disabled, WAN in the N53 band 630 may be disabled and BT, BLE, and WLAN 2.4 GHz transmission may be turned on (e.g., block 812 of operations 800).

### Example Aspects

In addition to the various aspects described above, specific combinations of aspects are within the scope of the present disclosure, some of which are detailed below:

Aspect 1: A method, comprising: detecting a condition involving concurrent operation of one or more radio access technologies (RATs) in a first radio frequency (RF) band and a second RF band, wherein the first and second RF bands comprise at least one of adjacent or overlapping RF bands; and performing one or more actions to adjust one or more RF operation parameters based on the detecting of the condition.

Aspect 2: The method of Aspect 1, wherein: the one or more RATs comprise at least one of Bluetooth (BT), BT low energy (BLE), or wireless local area network (WLAN).

Aspect 3: The method of Aspect 1 or 2, wherein: the condition involves detecting an N53 band is enabled; and the one or more actions comprise creating a restricted spectrum by forming a guard band using a portion of the first RF band that is at least one of adjacent to or overlapping the second RF band.

Aspect 4: The method of Aspects 1 or 2, wherein the one or more actions comprise switching an RF path to a first path that includes a narrow band filter associated with an N53 band.

Aspect 5: The method according to any of Aspects 1-4, further comprising temporarily disabling operation on at least a portion of the first RF band while performing the one or more actions.

Aspect 6: The method of Aspect 3, further comprising prioritizing operation of a first RAT of the one or more RATs over a second RAT of the one or more RATs in the restricted spectrum.

Aspect 7: The method of Aspect 6, wherein the prioritizing is accomplished by disabling operation of the second RAT in the restricted spectrum.

Aspect 8: The method according to any of Aspects 3, 5, and 7, further comprising limiting operation of at least a first RAT of the one or more RATs to approved channels in the restricted spectrum.

Aspect 9: The method according to any of Aspects 3, 5, 7, and 8, further comprising: detecting the N53 band is disabled; and removing the guard band in response to detecting the N53 band is disabled.

Aspect 10: The method of Aspect 9, wherein the guard band is removed by switching an RF path to a second path.

Aspect 11: The method of Aspect 9 or 10, further comprising temporarily disabling operation on at least a portion of the first RF band while removing the guard band.

Aspect 12: The method according to any of Aspects 9-11, further comprising disabling prioritizing operation of a first RAT of the one or more RATs over a second RAT of the one or more RATs in the restricted spectrum by enabling operation of the second RAT in the first RF band.

Aspect 13: The method according to any of Aspects 9-12, further comprising removing a limitation of operation of at least a first RAT of the one or more RATs to approved channels in the restricted spectrum.

Aspect 14: A method, comprising: detecting a condition involving concurrent operation of two or more RATs in a first RF band and a second RF band, wherein the first and second RF bands comprise at least one of adjacent or overlapping RF bands; disabling operation of at least a first RAT of the two or more RATs on at least a portion of the first RF band based on the detecting of the condition; performing one or more actions to adjust one or more RF operation parameters while operation of the first RAT is disabled; and enabling operation of the first RAT on at least the portion of the first RF band concurrent with operating on the second RF band using a second RAT after performing the one or more actions.

Aspect 15: The method of Aspect 14, further comprising disabling operation of a third RAT associated with the first RF band based on the detecting of the condition, and wherein operation of the third RAT on at least the portion of the first RF band remains disabled after performing the one or more actions for at least a duration of the detecting of the condition.

Aspect 16: The method of Aspect 14 or 15, wherein: the first RAT comprise at least one of BT, BLE, or WLAN.

Aspect 17: The method according to any of Aspects 14-16, wherein: the condition involves detecting an N53 band is enabled; and the one or more actions comprise creating a restricted spectrum by forming a guard band using a portion of the first RF band that is at least one of adjacent to or overlapping the second RF band.

Aspect 18: The method according to any of Aspects 14-16, wherein the one or more actions include switching an RF path to a first path that includes a narrow band filter associated with an N53 band.

Aspect 19: The method of Aspect 17, further comprising limiting operation of at least the first RAT to approved channels in the restricted spectrum.

Aspect 20: An RF front-end circuit, comprising: an antenna; and one or more switches for selecting: a first path from the antenna and through a first filter to an RF module; and a second path from the antenna and through a second filter to an RF module, wherein a bandwidth of the first filter overlaps with a bandwidth of the second filter, and wherein the bandwidth of the first filter is narrower than the bandwidth of the second filter.

Aspect 21: An apparatus for wireless communications, comprising: memory comprising computer-executable instructions; and one or more processors, individually or collectively, configured to execute the computer-executable instructions and cause the apparatus to: detect a condition involving concurrent operation of two or more RATs in a first RF band and a second RF band, wherein the first and second RF bands comprise at least one of adjacent or overlapping RF bands; disable operation of at least a first RAT of the two or more RATs on at least a portion of the first RF band based on the detection of the condition; perform one or more actions to adjust one or more RF operation parameters while operation of the first RAT is disabled; and enable operation of the first RAT on at least the portion of the first RF band concurrent with operating on the second RF band using a second RAT after the one or more actions are performed.

Aspect 22: An apparatus for wireless communications, comprising: means for detecting a condition involving concurrent operation of two or more RATs in a first RF band and a second RF band, wherein the first and second RF bands comprise at least one of adjacent or overlapping RF bands; means for disabling operation of at least a first RAT of the two or more RATs on at least a portion of the first RF band based on the detection of the condition; means for performing one or more actions to adjust one or more RF operation parameters while operation of the first RAT is disabled; and means for enabling operation of the first RAT on at least the portion of the first RF band concurrent with operating on the second RF band using a second RAT after the one or more actions are performed.

Aspect 23: An apparatus, comprising: memory comprising computer-executable instructions and one or more processors configured to execute the computer-executable instructions and cause the processing system to, individually or collectively, perform a method in accordance with any one of Aspects 1-19.

Aspect 24: An apparatus, comprising means for performing a method in accordance with any one of Aspects 1-19.

Aspect 25: A method, comprising: detecting a condition involving concurrent operation of two or more radio access technologies (RATs) in a first radio frequency (RF) band and a second RF band, wherein the first and second RF bands comprise at least one of adjacent or overlapping RF bands; disabling operation of at least a first RAT of the two or more RATs on at least a portion of the first RF band based on the detecting of the condition; performing one or more actions to adjust one or more RF operation parameters while operation of the first RAT is disabled; and enabling operation of the first RAT on at least the portion of the first RF band concurrent with operating on the second RF band using a second RAT after performing the one or more actions.

Aspect 26: The method of Aspect 25, further comprising disabling operation of a third RAT associated with the first RF band based on the detecting of the condition, wherein operation of the third RAT on at least the portion of the first RF band remains disabled after performing the one or more actions for at least a duration of the detecting of the condition.

Aspect 27: The method of Aspect 25 or 26, wherein: the first RAT comprises at least one of Bluetooth (BT), BT low energy (BLE), or wireless local area network (WLAN).

Aspect 28: The method according to any of Aspects 25-27, wherein: the condition involves detecting an N53 band is enabled; and the one or more actions comprise creating a restricted spectrum by forming a guard band using a portion of the first RF band that is at least one of adjacent to or overlapping the second RF band.

Aspect 29: The method according to any of Aspects 25-28, wherein the one or more actions comprise switching an RF path to a path that includes a narrow band filter associated with an N53 band.

Aspect 30: The method of Aspect 28 or 29, further comprising limiting operation of at least the first RAT to approved channels in the restricted spectrum.

Aspect 31: The method according to any of Aspects 28-30, wherein the guard band comprises a 20 MHz guard band.

Aspect 32: The method according to any of Aspects 28-31, further comprising: a period of time after detecting the N53 band is enabled, detecting that the N53 band is disabled; and removing the guard band to form an unrestricted spectrum.

Aspect 33: The method of Aspect 32, wherein removing the guard band comprises switching an RF path to a path that includes a wideband filter associated with a 2.4 GHz band.

Aspect 34: The method according to any of Aspects 31-33, further comprising removing a limitation of operation of at least the first RAT to approved channels in the restricted spectrum.

Aspect 35: The method according to any of Aspects 25-34, wherein: the first RAT comprises at least one of Bluetooth (BT) or BT low energy (BLE); and the second RAT comprises wide area network (WAN).

Aspect 36: An apparatus for wireless communications, comprising: memory comprising computer-executable instructions; and one or more processors configured, individually or collectively, to execute the computer-executable instructions and cause the apparatus to: detect a condition involving concurrent operation of two or more radio access technologies (RATs) in a first radio frequency (RF) band and a second RF band, wherein the first and second RF bands comprise at least one of adjacent or overlapping RF bands; disable operation of at least a first RAT of the two or more RATs on at least a portion of the first RF band based on the detection of the condition; perform one or more actions to adjust one or more RF operation parameters while operation of the first RAT is disabled; and enable operation of the first RAT on at least the portion of the first RF band concurrent with operating on the second RF band using a second RAT after the one or more actions are performed.

Aspect 37: The apparatus of Aspect 36, wherein the one or more processors are further configured, individually or collectively, to execute the computer-executable instructions and cause the apparatus to disable operation of a third RAT associated with the first RF band based on the detection of the condition, wherein operation of the third RAT on at least the portion of the first RF band remains disabled after the one or more actions are performed for at least a duration of the detection of the condition.

Aspect 38: The apparatus of Aspect 36 or 37, wherein the first RAT comprises at least one of Bluetooth (BT), BT low energy (BLE), or wireless local area network (WLAN).

Aspect 39: The apparatus according to any of Aspects 36-38, wherein: the condition involves detecting an N53 band is enabled; and to perform the one or more actions, the one or more processors are configured, individually or collectively, to execute the computer-executable instructions and cause the apparatus to create a restricted spectrum by forming a guard band using a portion of the first RF band that is at least one of adjacent to or overlapping the second RF band.

Aspect 40: The apparatus of Aspect 39, wherein to perform the one or more actions, the one or more processors are further configured, individually or collectively, to execute the computer-executable instructions and cause the apparatus to switch an RF path to a path that includes a narrow band filter associated with the N53 band.

Aspect 41: The apparatus of Aspect 39 or 40, wherein the one or more processors are further configured, individually or collectively, to execute the computer-executable instructions and cause the apparatus to limit operation of at least the first RAT to approved channels in the restricted spectrum.

Aspect 42: The apparatus according to any of Aspects 39-41, wherein the guard band comprises a 20 MHz guard band.

Aspect 43: A radio frequency (RF) front-end circuit, comprising: a first filter; a second filter; an RF module; and one or more switches configured to selectively establish: a first path from an antenna and through the first filter to the RF module; and a second path from the antenna and through the second filter to the RF module, wherein a bandwidth of the first filter overlaps with a bandwidth of the second filter and wherein the bandwidth of the first filter is narrower than the bandwidth of the second filter.

Aspect 44: The RF front-end circuit of Aspect 43, wherein the bandwidth of the first filter comprises a first range of frequencies from 2400 MHz to 2463 MHz and wherein the bandwidth of the second filter comprises a second range of frequencies from 2400 MHz to 2483 MHz.

Aspect 45: The RF front-end circuit of Aspect 43 or 44, further comprising a controller configured to: disable operation of a RAT associated with the RF module on at least a portion of a first RF band; selectively establish the first path; and enable operation of the RAT on the at least the portion of the first RF band in response to selectively establishing the first path.

Aspect 46: An apparatus, comprising means for performing a method in accordance with any one of Aspects 25-35.

### Additional Considerations

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “memory,” “a memory,” “at least one memory,” or “one or more memories” generally refers to a single memory configured to store data and/or instructions, multiple memories configured to collectively store data and/or instructions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method, comprising:
detecting a condition involving concurrent operation of two or more radio access technologies (RATs) in a first radio frequency (RF) band and a second RF band, wherein the first and second RF bands comprise at least one of adjacent or overlapping RF bands;
disabling operation of at least a first RAT of the two or more RATs on at least a portion of the first RF band based on the detecting of the condition;
performing one or more actions to adjust one or more RF operation parameters while operation of the first RAT is disabled; and
enabling operation of the first RAT on at least the portion of the first RF band concurrent with operating on the second RF band using a second RAT after performing the one or more actions.

2. The method of claim 1, further comprising disabling operation of a third RAT associated with the first RF band based on the detecting of the condition, wherein operation of the third RAT on at least the portion of the first RF band remains disabled after performing the one or more actions for at least a duration of the detecting of the condition.

3. The method of claim 1, wherein the first RAT comprises at least one of Bluetooth (BT), BT low energy (BLE), or wireless local area network (WLAN).

4. The method of claim 1, wherein the one or more actions comprise switching an RF path to a path that includes a narrow band filter associated with an N53 band.

5. The method of claim 1, wherein:
the condition involves detecting an N53 band is enabled; and
the one or more actions comprise creating a restricted spectrum by forming a guard band using a portion of the first RF band that is at least one of adjacent to or overlapping the second RF band.

6. The method of claim 5, further comprising limiting operation of at least the first RAT to approved channels in the restricted spectrum.

7. The method of claim 5, wherein the guard band comprises a 20 MHz guard band.

8. The method of claim 5, further comprising:
a period of time after detecting the N53 band is enabled, detecting that the N53 band is disabled; and
removing the guard band to form an unrestricted spectrum.

9. The method of claim 8, wherein removing the guard band comprises switching an RF path to a path that includes a wideband filter associated with a 2.4 GHz band.

10. The method of claim 8, further comprising removing a limitation of operation of at least the first RAT to approved channels in the restricted spectrum.

11. An apparatus for wireless communications, comprising:
memory comprising computer-executable instructions; and
one or more processors configured, individually or collectively, to execute the computer-executable instructions and cause the apparatus to:
detect a condition involving concurrent operation of two or more radio access technologies (RATs) in a first radio frequency (RF) band and a second RF band, wherein the first and second RF bands comprise at least one of adjacent or overlapping RF bands;
disable operation of at least a first RAT of the two or more RATs on at least a portion of the first RF band based on the detection of the condition;
perform one or more actions to adjust one or more RF operation parameters while operation of the first RAT is disabled; and
enable operation of the first RAT on at least the portion of the first RF band concurrent with operating on the second RF band using a second RAT after the one or more actions are performed.

12. The apparatus of claim 11, wherein the one or more processors are further configured, individually or collectively, to execute the computer-executable instructions and cause the apparatus to disable operation of a third RAT associated with the first RF band based on the detection of the condition, wherein operation of the third RAT on at least the portion of the first RF band remains disabled after the one or more actions are performed for at least a duration of the detection of the condition.

13. The apparatus of claim 11, wherein the first RAT comprises at least one of Bluetooth (BT), BT low energy (BLE), or wireless local area network (WLAN).

14. The apparatus of claim 11, wherein:
the condition involves detecting an N53 band is enabled; and
to perform the one or more actions, the one or more processors are configured, individually or collectively, to execute the computer-executable instructions and cause the apparatus to create a restricted spectrum by forming a guard band using a portion of the first RF band that is at least one of adjacent to or overlapping the second RF band.

15. The apparatus of claim 14, wherein to perform the one or more actions, the one or more processors are further configured, individually or collectively, to execute the computer-executable instructions and cause the apparatus to switch an RF path to a path that includes a narrow band filter associated with the N53 band.

16. The apparatus of claim 14, wherein the one or more processors are further configured, individually or collectively, to execute the computer-executable instructions and cause the apparatus to limit operation of at least the first RAT to approved channels in the restricted spectrum.

17. The apparatus of claim 14, wherein the guard band comprises a 20 MHz guard band.

18. A radio frequency (RF) front-end circuit, comprising:
a first filter;
a second filter;
an RF module; and
one or more switches configured to selectively establish:
a first path from an antenna and through the first filter to the RF module; and
a second path from the antenna and through the second filter to the RF module, wherein a bandwidth of the first filter overlaps with a bandwidth of the second filter and wherein the bandwidth of the first filter is narrower than the bandwidth of the second filter.

19. The RF front-end circuit of claim 18, wherein the bandwidth of the first filter comprises a first range of frequencies from 2400 MHz to 2463 MHz and wherein the bandwidth of the second filter comprises a second range of frequencies from 2400 MHz to 2483 MHz.

20. The RF front-end circuit of claim 18, further comprising a controller configured to:
disable operation of a radio access technology (RAT) associated with the RF module on at least a portion of a first RF band;
selectively establish the first path; and
enable operation of the RAT on the at least the portion of the first RF band in response to selectively establishing the first path.
